(19) United States
(12) Patent Application Publication
(10) Pub. No.: US 2021/0026499 A1
(43) Pub. Date: Jan. 28, 2021

(54) SYSTEM AND METHOD FOR AUTOMATING VISUAL LAYOUT OF HIERARCHICAL DATA

(71) Applicant: Xerox Corporation, Norwalk, CT (US)

(72) Inventors: Noah John David Ullmann, Rochester, NY (US); Keith S. Watson, Spencerport, NY (US); Ken Hayward, Brockport, NY (US); Nermine A. Zakhary, Rochester, NY (US); Benjamin Duthu, Paris (FR)

(21) Appl. No.: 16/519,182

(22) Filed: Jul. 23, 2019

(51) Int. Cl. G06F 3/0481; G06T 11/00

(52) U.S. Cl. CPC G06F 3/0481; G06T 11/001

(57) ABSTRACT

A system displays hierarchical data via a graphical user interface in a concentric ring structure. Data elements of adjacent cells in any two rings will share a parent-child relationship. Data elements will be associated with metadata that the system uses to determine a visual representation, such as font type, color, or other features. As various filters are applied, the visual representation may change as the system applies the filter to the metadata.

### BACKGROUND

There is a tremendous need to make complex data sets visual and actionable to human viewers. In complex systems that require people to collaborate, communicating complex data sets can be challenging. This challenge increases as the complexity of the data sets and activities associated with them grows. Although communication tools such as e-mail, spreadsheets and electronic presentation systems are available, existing systems are not sufficient to adequately visualize complex systems. For example, Microsoft Office offers the ability to visualize data in a “sunburst chart” in which each level of a hierarchical data set is represented by a ring or circle, with the innermost ring representing the top of the hierarchy. A sunburst chart shows how the data in the outer rings is related to that of the inner rings. An example is shown in FIG. 1, in which color is used to show which cells of an outer ring and cells of an inner ring are related in the hierarchy (i.e., cells of a common color are related to each other). (Since FIG. 1 is in black-and-white, in this patent document we use different cell background patterns to represent different colors.)

This document describes a system and method for addressing at least some of the problems described above.

### SUMMARY

In various embodiments, a system displays hierarchical data via a graphical user interface. The system includes a data set of hierarchical data elements. Each of the data elements is associated with a parent category and/or one or more child categories, as well as with metadata stored in the data set. The system includes programming instructions that are configured to generate and cause the display device to dynamically display a visual representation of the data set in a concentric ring structure. The system will configure the ring structure by selecting a first data element from the data set. The first data element will be associated with a parent category. The system will display the first data element in a cell of a central ring of the concentric ring structure. The system will extract, from the data set, each additional data element that is associated with a category that is a child category of the parent category of the first informational element. The system will then display the extracted additional data elements in cells of a first outer ring that is outside of and adjacent to the central ring in the concentric ring structure. The system will identify a filter to be applied to the visual representation. The filter will include one or more parameters that, if satisfied by information displayed in any cell of the ring structure, will cause that cell to exhibit an altered appearance rather than a default appearance. The system will analyze the first data element and some or all of the additional data elements to identify each data element having associated metadata that satisfies the parameter(s). The system will then output, via the display device, the concentric ring structure populated with the first data element and each additional data element in a visual representation in which: (a) each cell that displays a data element having associated metadata that satisfies the one or more parameters is displayed with an altered appearance; and (b) each cell that displays a data element having associated metadata that does not satisfy the one or more parameters is displayed with the default appearance. The system may be integrated into a multi-function printing device, or into any other system that includes a processor and display device.

In various embodiments, the altered appearance may include any or all of the following: (1) a background color that differs from a background color of the default appearance; (2) a font color that differs from a font color of the default appearance; or (3) a font appearance that differs from a font appearance of the default appearance.

Optionally, the concentric ring structure may include multiple rings. For example, the system may identify and extract, from the data set, any child data element that is associated with a child category of the category of the additional informational element. The system may then display each child data element in a cell of a second outer ring of the concentric ring structure. Each cell in the second outer ring will display a child data element that is adjacent to and outside of the cell of the first outer ring that displays the additional data element from which it is a child. The system will analyze each child data element to identify whether it has associated metadata that satisfies the one or more parameters of the filter, and it will cause the display device to present the second outer ring in a visual format in which: (a) each cell that displays a child data element having associated metadata that satisfies the one or more parameters is displayed with an altered appearance; and (b) each cell that displays a child data element having associated metadata that does not satisfy the one or more parameters is displayed with the default appearance.

After the system has populated and displayed a ring structure, it may receive a user selection of a new filter. If so, it may cause the display device to present each cell in a visual format in which: (a) each cell that displays a data element having associated metadata that satisfies the new filter exhibits an newly altered appearance; and (b) each cell that displays a data element having associated metadata that does not satisfy the new filter exhibits an unchanged appearance.

In some embodiments, the system may offer the option of displaying multiple panes at once. For example, the system may display a comparison view by identifying an additional data set and causing the display device to also display the additional data set in a second concentric ring structure. If the view is a progression view, the second data set may be an earlier or later version of the data set that is used for the first ring structure. In either option, upon detection of a user selection of one of the displayed data elements in either of the concentric ring structures the system may synchronize the two displayed charts by: (1) causing the display device to move the displayed data element to the central ring of each of the concentric ring structures; (2) identifying and extracting, from the data set, any child data element that is a child of the selected informational element; and (3) causing the display device to display each child data element in a corresponding cell of the first outer ring of each concentric ring structure.

In some embodiments, upon detection of a user selection of one of the displayed data elements, the system may retrieve and display (in a content field) content that is associated with the selected data element. The system may retrieve the content that is associated with the data element of the selected cell by: (a) extracting, from the data set, content that is associated with the data element of the selected cell; or (b) identifying a content source from metadata of the data element of the selected cell, and accessing the content source to retrieve the content from the content source.

In some embodiments, a system for presenting hierarchical data via a graphical user interface includes a display device, a processor, and programming instructions that are configured to generate and cause the display device to dynamically display hierarchical data in two or more concentric ring structures by accessing a first data set of hierarchical data elements and causing the display device to present the first data set in a first concentric ring structure. The first concentric ring structure includes two or more rings, each ring comprises a plurality of cells, and each cell displays one of the data elements of the first set. The system also will access a second data set of hierarchical data elements, and it will cause the display device to present the second data set in a second concentric ring structure along with the first concentric ring structure. Optionally, the second data set may be an earlier version or a later version of the first data set. The second concentric ring structure also includes two or more rings, each ring comprises a plurality of cells, and each cell displays one of the data elements of the second set. When the system receives a user's selection of a cell in either of the concentric ring structures, then the system will synchronize navigation by, for both the first and second concentric ring structures, causing the display device to move the data element of the selected cell to a central ring of that concentric ring structure. The system will then identify and extract, from the first data set and the second data set, any child data element that is a child of the data element of the selected cell. It will display each child data element extracted from the first data set in a corresponding cell of the first concentric ring structure, and it will display each child data element extracted from the second data set in a corresponding cell of the second concentric ring structure.

Optionally, when presenting the first data set in the first concentric ring structure, the system may identify, as a first central data element, a data element in the central ring of the first concentric ring structure. The first data element will associated with a category. The system will extract, from the first data set, each first additional data element that is associated with a category that is a child category of the category of the first central data element. The system will identify a first filter that includes one or more parameters. For the first central data element and each of the first additional data elements, the system will analyze metadata for that data element and apply the parameters to that data element's metadata to determine an appearance for the cell in which the data element will appear. The system will then cause the display device to display the extracted first additional data elements in cells of a ring that is outside of and adjacent to the central ring in the first concentric ring structure, and when doing so the system will present each cell according to its determined appearance.

When presenting the second data set in the second concentric ring structure, the system may similarly identify, as a second central data element, a data element in the central ring of the second concentric ring structure. The second central data element also may be associated with a category. The system will extract, from the data set, each additional data element that is associated with a category that is a child category of the category of the second central data element. The system will identify a second filter that includes one or more second parameters. For the second central data element and each of the second additional data elements, the system will analyze metadata for that data element and apply the second parameters to that data element's metadata to determine an appearance for the cell in which the data element will appear. The system will then cause the display device to display the extracted second additional data elements in cells of a ring that is outside of and adjacent to the central ring in the second concentric ring structure, and when doing so the system will present each cell according to its determined appearance.

Optionally, when determining the appearance for the cell in which a data element will appear, the system may: (a) if the metadata for the data element satisfies the one or more parameters, display the data element with an altered appearance; and (b) if the metadata for the first data element does not satisfy the one or more parameters, display the data element with the default appearance.

Optionally, upon detecting a user selection of the central ring of either of the concentric ring structures, then for each of the first and second concentric ring structures the system may move the data element that was in the central ring to a cell that is within an outer ring that is adjacent to the central ring of that concentric ring structure, and it may populate the central ring with a parent of the data element that was in the central ring. Alternatively or in addition, upon detecting a user selection of the central ring of either of the concentric ring structures, the system may revise each of the first and second concentric ring structures to present an immediately prior view for the user who made the user selection.

Optionally, in some embodiments, upon detecting a user selection of a selected cell the system may retrieve content that is associated with the data element of the selected cell by: (a) extracting, from the data set for that data element, content that is associated with the data element of the selected cell; or (b) identifying a content source from metadata of the data element of the selected cell, and accessing the content source to retrieve the content from the content source. The system may then cause the display device to display the retrieved content in a content field.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example of a sunburst chart, as may be found in the prior art.

FIG. 2 illustrates an example system for displaying hierarchical data.

FIG. 3 illustrates an example graphical user interface (“GUI”) that illustrates hierarchical data.

FIG. 4 illustrates hierarchical data and how it may be extracted and presented via a GUI.

FIGS. 5A and 5B illustrate how the system may enable a user to navigate through hierarchical data.

FIG. 6 illustrates how hierarchical data may include tags that may be used by a filtering function to determine the data elements that are displayed in a GUI.

FIG. 7 illustrates how both filters and overlays may affect the appearance of hierarchical data in a GUI.

FIGS. 8A and 8B illustrate how the system may display a comparison of hierarchical data with multiple panes having different filters and/or graphical overlays are applied to the data.

FIGS. 9A to 9C show how the comparison tool may display a progression view of how a product or process changes over time.

FIG. 10 is a flowchart illustrating an example hierarchical data visualization process.

FIG. 11 illustrates example components of computing hardware that may implement some or all of the processes described in this patent document.

### DETAILED DESCRIPTION

Terminology that is relevant to this disclosure will be presented at the end of this section.

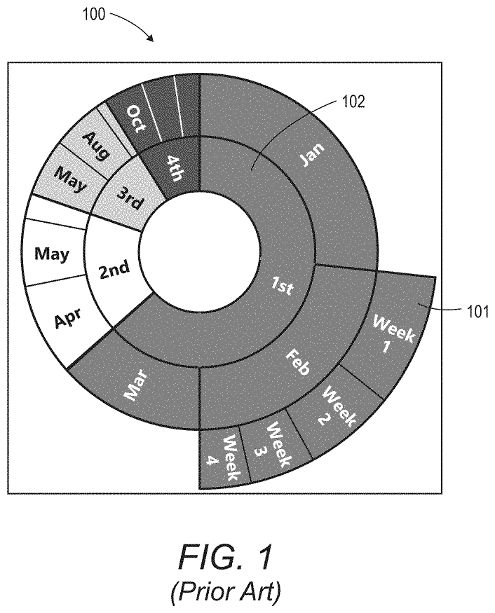

The system described in this document solves technical problems that exist with prior data visualization systems. A typical sunburst chart of the prior art cannot fully present relationships between hierarchical data elements in multiple, higher-level dimensions. Instead, the point-and-click method of navigating through existing sunburst charts only allows visualization of data in two dimensions as shown in FIG. 1, without shape or breadth.

The system described below provides unique multi-level segmented charts, novel navigation techniques, metadata driven overlays that provide contextual information at the point of need), and unique starting positions (i.e., unique custom entry points for groups) and/or comparisons (i.e., the ability to show multiple “pane views” of hierarchical data), as well as the ability to keep two or more displayed charts in sync while a user navigates through one of the displayed charts.

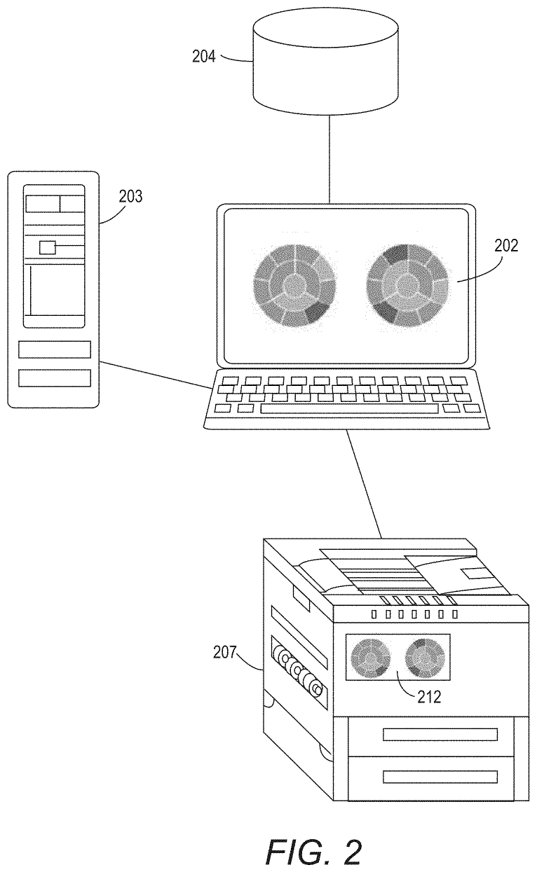

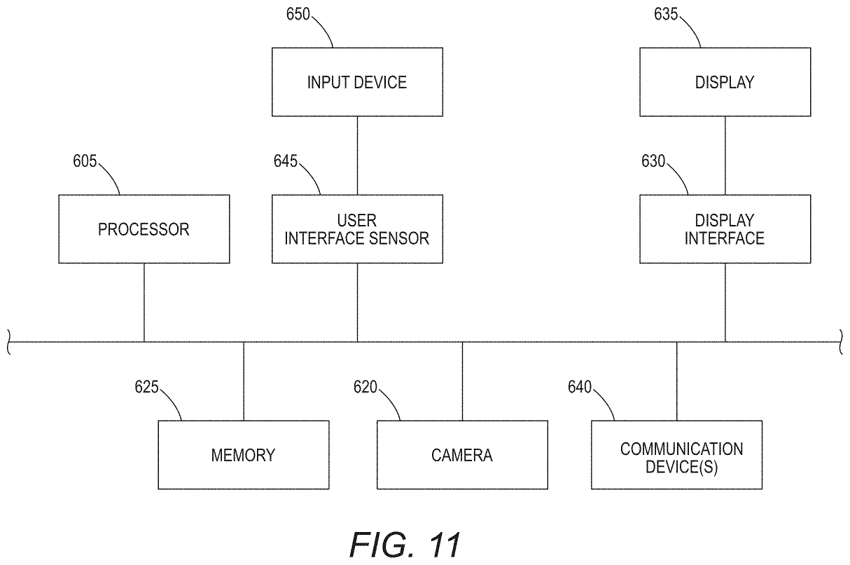

FIG. 2 illustrates example hardware elements of a system for displaying hierarchical data. The system will include a computing device 201 that includes a processor, memory, graphics card and/or other components, examples of which will be discussed below in the context of FIG. 11. The computing device 201 will include or will be communicatively connected to a display device 202. A non-transitory memory device containing computer-readable programming instructions that are configured to cause the display device to output a graphical user interface may be integral with the computing device, and/or memory may be part of an external server 203 that is communicatively connected with the computing device 201. A non-transitory memory device containing a data set of hierarchical data may be integral with the computing device 201, and/or the data set may be part of an external data store 204 that is communicatively connected with the computing device 201. The server 203 and data store 204 may be separate as shown, or they may be elements of a common system or device. In some embodiments, the computing device may be integrated into a printer such as a multi-function printing device (MFD) 207, which is a machine that includes a print engine (hardware and associated software, such as print heads, a substrate transport system, and print drivers) configured to enable the device to print documents on substrates, as well as perform at least one other function such as copying, facsimile transmitting and/or receiving, image scanning, or performing other actions on document-based data. If so, the display 212 may be a component of the MFD 207, and the user interfaces discussed below may be implemented by the MFD's display 212 and/or other user input elements of the MFD.

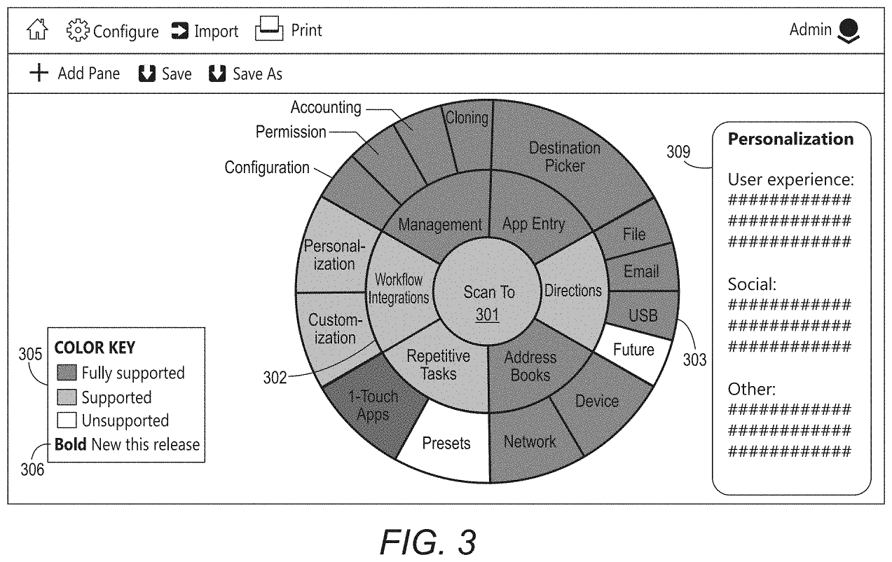

FIG. 3 illustrates an example of a hierarchical data display system, which includes a graphical user interface (“GUI”) 300 that would be output on a display such as that shown in FIG. 2. The GUI outputs a chart that provides a visualization of hierarchical data in a concentric ring structure, which is a visual display of one or more concentric rings around a central ring, in which each ring includes one or more cells that display content. Data that is associated with a first parent category will be displayed in a first, central ring 301 of the concentric ring structure. Data that is a child (e.g., as a subcategory) of the first parent category will be displayed in a first outer ring 302 that is outside of and adjacent to the central ring. Optionally, a second outer ring 303 that is outside of and adjacent to the first outer ring 302 may display data that is a child (e.g., as a subcategory) of the data of first outer ring 302. Any number of additional rings may continue outside of the second outer ring 303 following this format. (Note: in this document the term “ring” does not require a complete circle. A semi-circle, or even a single cell, may serve as a ring, especially if only some, but not all, data elements of an inner ring are associated with child data elements on the adjacent outer ring. See FIG. l′s outer ring as an example.)

The data of each ring is presented in one or more cells. Data elements that are a child of the data element of any particular cell will be presented in the adjacent cells located on the next outer ring. An example of this is shown in FIG. 3, which shows example capabilities of a multi-function print device. The central ring 301 shows that the print device supports a “Scan To” function, while the first outer ring 302 shows various subcategories of the scan to function. One example is the “Address Book” function, which is associated with the subcategories “Device” and “Network” in the second outer ring 303, indicating that the print device may access address books that are either located on the print device, as well as remote address books that are available via a network.

In addition to being associated with parent and/or child data elements, each data element may be associated with metadata in the data set. The metadata may be stored in the data set (e.g., in the memory of the computing device 201 and/or external data store 204) with the data element. The system may extract the metadata from the data set and the metadata to map the data element to an appearance parameter for any cell that presents the data, thus providing an additional dimension of data visualization. (Mapping of metadata values also may be stored in memory, as a rule set, table, or by another suitable data structure.) The system also may use the metadata to identify and secure additional content that will be displayed in fields along with the concentric ring structure.

As noted above, the system may define an appearance parameter of any cell based on metadata that is associated with the content of the cell. An appearance parameter is a parameter that the system may use to determine a visual characteristic for the cell, where the visual characteristic provides in a format that is altered with respect to a default format, such as in a particular color or background pattern. For example, FIG. 3 shows that the GUI includes a color key 305 indicating that the background color of each cell indicates whether the displayed function is fully supported, partially supported, or unsupported by the print device.

Another example of an appearance parameter that the system may use to determine a visual characteristic for the cell is font type. Font type may refer to style of the font (such as bold, italic, size, etc.) and/or the typeface of font (such as Arial, Calibri, Courier, Times, etc.). The GUI 300 of FIG. 3 also includes an appearance key element 306 indicating that cells in which the text is presented in bold font illustrate that the feature was newly added in the current product release.

Further, the metadata for any data element may include, or serve as a pointer to, content that provides additional information about the data element. The GUI 300 may include a content field 309 that displays the content that is associated with a data element when the system receives a user selection of a data element (such as by touching, mouse-clicking, or hovering over the data element's cell). In the example shown in FIG. 3, content displayed in content field 309 is associated with the “Personalization” data element. The content that is associated with the data element and displayed in content field 309 may be stored in the data set with the data element and extracted from the data set when the data element's cell is selected. Alternatively, the content that is associated with the data element and displayed in content field 309 may be extracted from a different data set, or it may be accessed from an external source via a hyperlink, application programming interface (API) or other actionable data retrieval device that is associated with the selected data element. In addition, instead of selecting the content based on which cell a user selects, the system may automatically select a cell (and the metadata associated with that cell's data element), using any suitable selection process. For example, the system may select and display content for a default cell (e.g., the center ring), for a cell that the system selects by random process, or by another method.

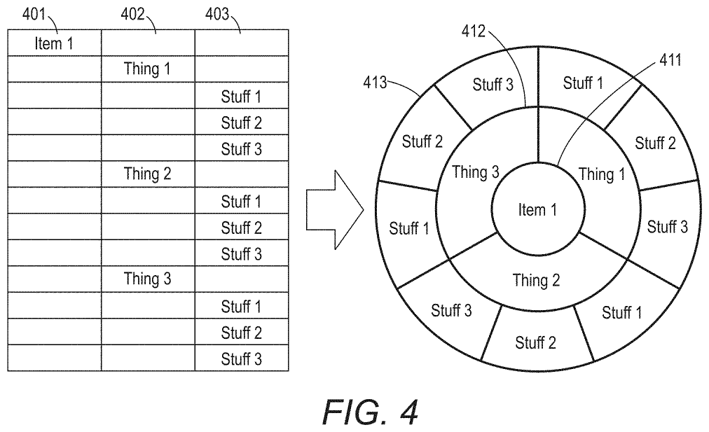

The hierarchical data stored in the data set (such as in data store 204 of FIG. 2) will include certain attributes, and in particular one or more categories, to help accomplish the visualization of FIG. 3. Each category will be related to at least one other category as either a parent or child of the other category. FIG. 4 helps to illustrate this, as data from a spreadsheet may be associated with a first category “Item 1” 401. The first category “Item 1” 401 is a parent for the second categories 402 (“Thing 1,” “Thing 2” and “Thing 3”). Each of the second categories 402 is a child (subcategory) of the first category 401 and also a parent for one or more sub-subcategories (third categories 403). The system then displays the data elements of each category with the data element for the first category data displayed in the central ring 411, the data elements for the second category displayed in the first outer ring 412 that surrounds and is adjacent to the central ring 411, and the data elements for the third category displayed in the second outer ring 413 that surrounds and is adjacent to the first outer ring.

When a user selects one of the data elements of the GUI (such as by using an input device to highlight it, click on it, hover over it, speak the data element's text via audio input or otherwise), that data element may move to the central ring and become the ultimate parent that is displayed at the time, with one or more subcategories, displayed on outer rings as described above. If the user selects a data element in the first outer ring (i.e., the ring closest to the central ring), the system may display one level down in the data set. If the user selects a data element in the second outer ring, the system may display two levels down in the data set. This hierarchy continues based on the number of ring displayed. When a user selects a central ring, the system will move one level up in the data set.

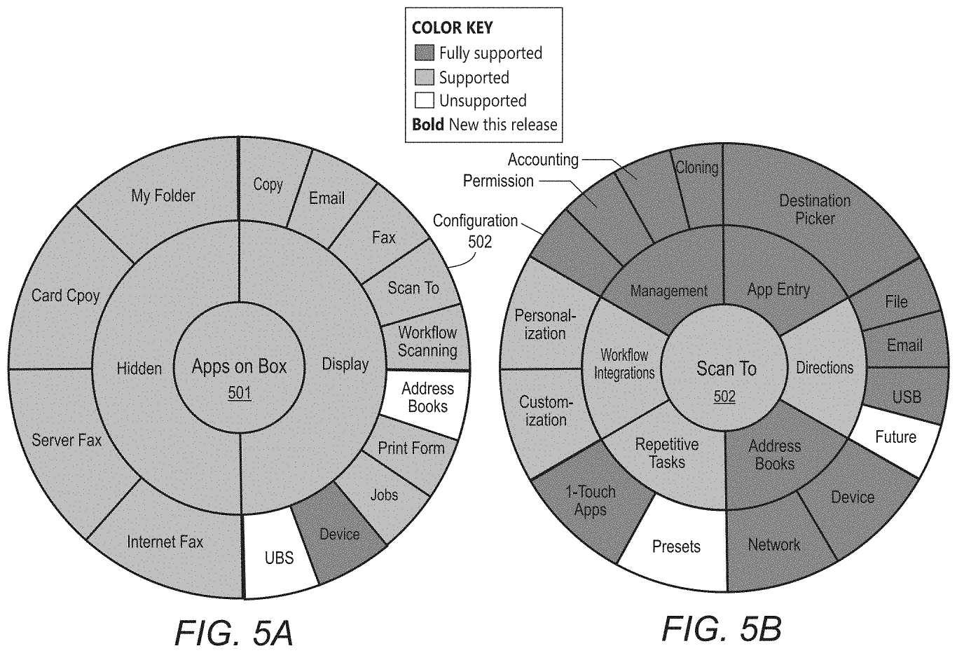

By way of example, refer to FIGS. 5A and 5B. In FIG. 5A, which illustrate example data elements that relate to functions of a print device such as an MFD. The functions may be used, for example, in a type of user help or support function that enables the user to review functions available on the MFD. The ultimate parent cell (central ring) displays the “Apps on Box” data element 501 which represents an inventory of all applications that are installed in a print device. The first outer ring subcategorizes the apps as displayed or hidden, and the second outer ring displays the available apps of each subcategory. One of the available apps is the “Scan To” function 502. When a user uses an input device to select the “Scan To” function 502, the chart changes its appearance to that shown in FIG. 5B, in which the selected “Scan To” data element 502 moves to the central ring, becoming the ultimate parent data element displayed at the time. The first outer ring displays children (subcategories) of the “Scan To” data element 502, while the second outer ring displays children of the first outer ring's data elements. If the user would then select the “Scan To” data element 502 in FIG. 5B, the “Scan To” data element 502 would move up one level to the first outer ring. The system also may save the user's navigation history (i.e., a breadcrumb-like trail), so that the system may access the user's navigation history, and identify and present the view (i.e., data layout and cell structure) that the system displayed immediately prior to implementing the user's command that placed the current data element in the central ring. This allows a user to retrace his or her navigation steps by selecting the center ring and/or using a back button on the user interface.

Each data element may be associated with one or more tags, i.e., metadata that reflects one or more parameters. In some embodiments, the tags can be used to determine an altered appearance (i.e., an appearance is different than a default appearance, or an appearance that is unique to a particular data grouping), such as a specific background color, text color, background pattern, font size, font type, font color, or other specified appearance attribute for the data cell when presented in the GUI. Each tag is associated with another attribute of the data element that can be represented in the chart. An example of this is shown in the GUI of FIG. 3, where a displayed key panel includes a color key 305 which explains that each cell's background color indicates whether the cell's data element's metadata indicates that the data element is fully supported, partially supported, or unsupported in the current software product release. The appearance key 306 of the key panel indicates that bold font indicates that the data element's metadata identifies the data element as a newly supported function.

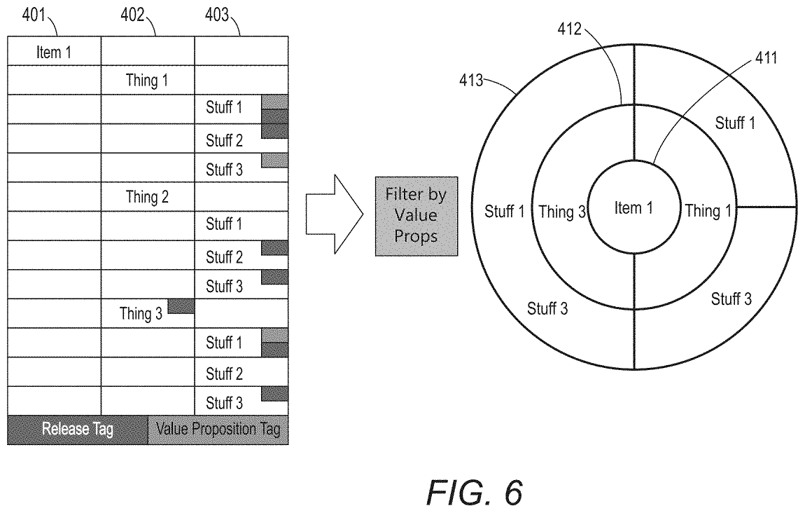

In some embodiments, the system can use metadata to filter the data elements and determine the data elements that will be displayed, thus affecting the structure of the GUI's concentric rings. For example, referring to FIG. 6, data elements of the third category 403 of the hierarchical data also have tags indicating if the data element relates to a first topic 424 (such as Value Proposition) or a second topic 425 (such as Release, which in this example indicates whether the data element is new in the product's current release). If so, the system or user may select a filter that applies to one or more of the tags. For example, if the system filters the data by Value Proposition, and if so the concentric ring structure 411-413 of FIG. 6 only displays data elements that are associated with the Value Proposition tag (first topic 424) and not data elements that do not have that association. This process may use a non-destructive restructuring process in which the system does not change the underlying data in the data set, but it changes the appearance of the displayed data as different filters are applied. However, the embodiments claimed below are not limited to such a process, as optionally the system may offer the ability to change and/or update data stored in the data set via the GUI discussed above.

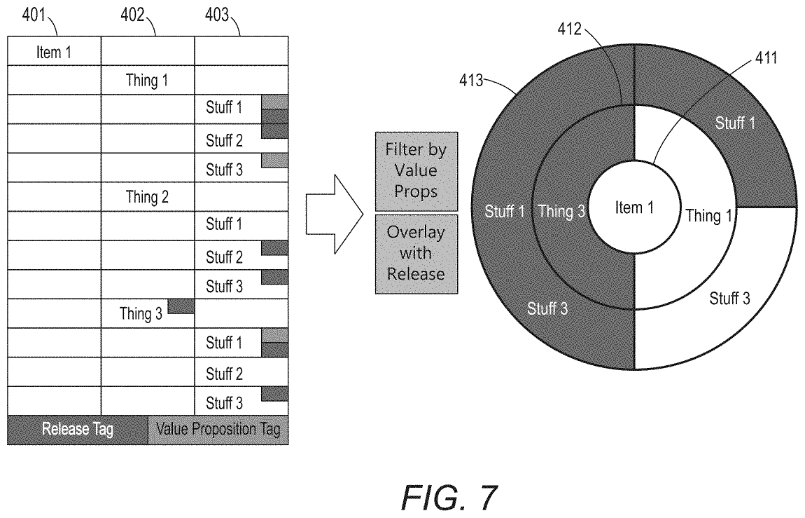

FIG. 7 illustrates that the system may enable the user to select multiple filters. Some of the filters may filter out (and not display) data elements that are not responsive to the filter's parameters (such as whether or not the data element is associated with Topic 1/Value Proposition). Other filters may include one or more parameters that, if satisfied, will cause the data element to exhibit an altered appearance (such as a first color if the data element is associated with Topic 2/New Release and a second color if the data element is not associated with Topic 2).

Optionally the system may include a “save view” function, in which one or more views that are displayed are saved into an appropriate location, such as the user's profile. This may be done automatically, such as the user's most recently active view, so that the system may return to that view the next time that the user accesses the system. In addition or alternatively, this may be done by user actuation, in which the user can choose to save a view to memory, and the system may provide the user with a menu of saved (or “favorite”) views that the user can retrieve at a later time.

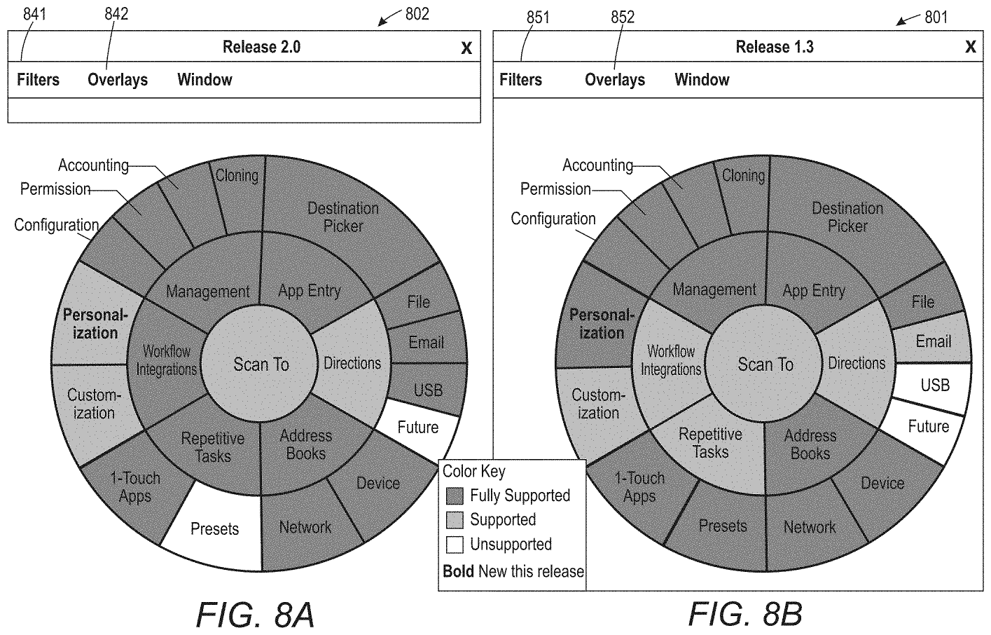

FIG. 8 illustrates that the system may offer a “comparison” display in which the system simultaneously outputs two or more GUIs, each of which includes the same data categories but with different filters applied, or with different data attributes over time shown. In the example of FIG. 8, each pane of the GUI represents the applications that are available on a particular platform of the scanning system that was originally presented in FIG. 3. In FIG. 8, the first pane 801 shows the applications that are available on a first product platform (i.e., Platform A), while the second pane 802 shows different product platform (i.e., Platform B). In Platform A (see first pane 801), some functions (such as Scan To/Destinations/USB) are not available, but those functions are available in the Platform B (see second pane 802). Other functions (such as Scan To/Destinations/Email) are partially supported Platform A and fully supported in Platform B. The absence or presence of a “supported” or “fully supported” tag with each product platform will indicate whether or not the function is partially supported, fully supported or unsupported. In some instances a function may be fully supported in Platform A but only partially supported in Platform B (example: personalization). The system may include user-selectable actuators that will select the parameters to be applied to the data elements and/or structure of each pane, such as a filters selector 841, 851 that identifies parameters that the system will use to select the data elements to be displayed and/or one or more attributes of the text of the data, and/or an overlay selector 842, 852 that identifies the parameters that the system will use to select the background color and/or pattern of each data element's cell.

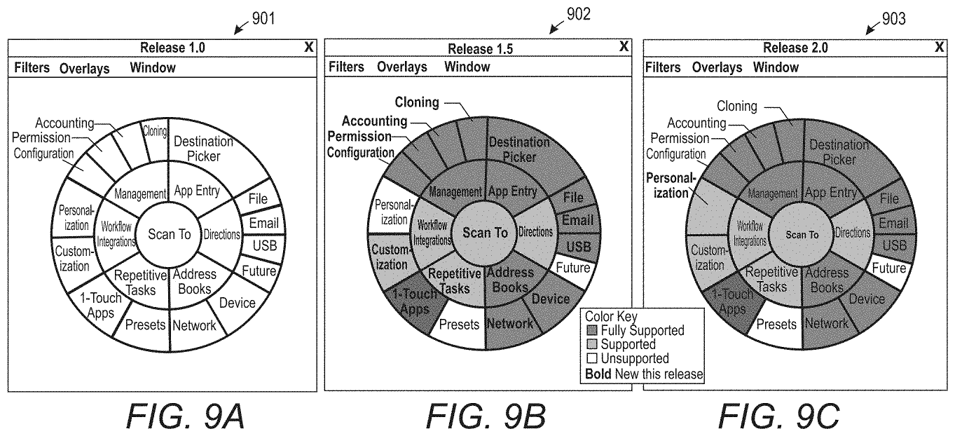

The comparison of two platforms shown in FIG. 8 is an example. The comparison tool can be used to compare other items. For example, as illustrated in FIG. 9, the comparison tool may be used to provide a progression view that illustrates functions available in a single product as different versions (i.e., release numbers) of that particular product become available over time. The first pane 901 represents a first release (v1.0) in which the “Scan To” function was not supported. The second pane 902 represents a later release (v1.5) in which the “Scan To” function was new (represented in bold font) and partially supported (as represented by the background pattern), with some subcategories fully supported and others partially supported or unsupported. The third pane 903 illustrates that in a third release (v2.0), some of the functions that were unsupported in v1.5 were added and partially supported, while some of the functions that were only partially supported in v1.5 became fully supported.

When in the comparison view of FIG. 8 or 9, the system also may synchronize the multiple panes so that each pane displays the same data structure, but with different visual characteristics representing different metadata. For example, the system may start with side-by-side comparisons of hierarchical data in which the central ring displays the ultimate parent data element “Apps on Box” (as in FIG. 5A), with different filters and/or overlays applied to each pane. When a user selects the “Scan To” data element on the outermost ring of that structure on one of the panes, the system will simultaneously move the “Scan To” data element to the central rings of all compared panes, as shown in FIG. 8.

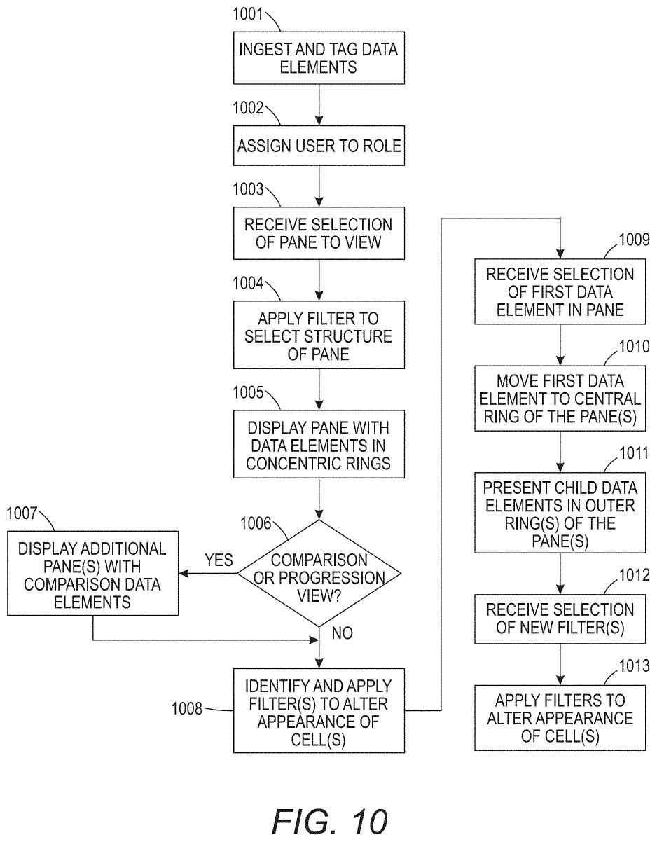

FIG. 10 illustrates an example workflow that a system for displaying hierarchical data may follow. To generate or update the data set of hierarchical data, may receive the data in a format such as a spreadsheet file. The system may ingest the data elements of the file and compile it (step 1001) to the data set by saving each data element with its parent and/or child relationships (as shown in FIGS. 4, 6 and 7) as well as tags with additional parameters (also as shown in FIGS. 6 and 7). To maintain consistent data structures, the system may establish a schema that spreadsheet authors must use to create a website, such as the schema shown in FIGS. 4, 6 and 7.

The system may receive a user credential that authorizes the user to access the hierarchical data and assign the user to a role (step 1002). The role may be user-specific, and the system may then create and/or access a user profile for the user. Some or all features of the role may be categorical, such as administrator or supervisor (which would have access to relatively more data elements) or guest (which would have access to relatively fewer data elements). The role is a set of rules or data that identifies the data elements that the user is permitted access, as well as views (i.e., assigned or user-selected combinations of filters and/or overlays) that are pre-defined for the user.

The system will select a pane to view (step 1003). A pane will be associated with a data set of data, such as data representing features of a product, a product version and/or other data. The data set may be a default data set, a user-selected data set, or an initial data set associated with the user in the user's profile. The system may select the pane as that which a user has selected via a user input element, such as by receiving a selection from a menu, drop-down field, free-form text or audio input. Alternatively, the system may select the pane automatically, such as by selecting a default pane, the last pane that the user viewed, the pane for which data was most recently updated or any other suitable automatic selection criteria. Optionally, the system may receive (or select a default) parameter that is a filter to keep certain data elements out of the pane's rings, thus affecting the structure of the pane and its rings (step 1004) as discussed above in the context of FIG. 6.

The system will then display the pane as data elements in concentric rings as discussed in various figures above (step 1005). If the user has selected (or if an automatically system-selected view is) a comparison or progression view (step 1006), the system will simultaneously display multiple panes (step 1007) as discussed above in the context of FIG. 8 or 9.

Before, when, or after displaying the pane(s), the system may receive a selection of one or more filters and/or identify one or more default filters, and it may apply the filter(s) (step 1008) to alter the appearance of one or more cells in each displayed pane. as discussed above in the context of FIGS. 3, 6, 8 and 9. To do this, the system will identify the data elements having associated metadata that satisfies one or more parameters of the filter(s) and cause the display to present the concentric ring(s) of each pane to output each cell so that: (i) each cell having a data element that does not satisfy the filter will exhibit a default appearance; and (ii) each cell having a data element that satisfies the filter will exhibit an altered appearance. As explained above, the altered appearance may include a particular background color or pattern, a particular font type, size or color or another specified appearance.

When the system receives a selection of a data element in one of the displayed panes (step 1009), it will move that data element to the central ring of each displayed pane (step 1010) and present the child (and optionally grandchild, great-grandchild, etc.) data elements for the selected data element in outer ring(s) around the central ring (step 1011).

In addition, when the system receives a selection of one or more new filter(s) (step 1012), it may apply the new filter(s) to dynamically alter the appearance of one or more cells of the displayed pane(s) to reflect the parameters of the new filter(s) (step 1013). Cells whose data elements satisfy a new filter may be changed to reflect an altered appearance for the new filter, while cells whose data elements do not satisfy the new filter may remain unchanged.

FIG. 11 depicts an example of internal hardware that may be included in any of the electronic components of the system, such as the user's smartphone or a local or remote computing device in the system. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 625. A memory device may include a single device or a collection of devices across which data and/or instructions are stored.

A display interface 630 may permit information from the bus 600 to be displayed on a display device 635 in visual, graphic or alphanumeric format. An audio interface and audio output (such as a speaker) also may be provided. Communication with external devices may occur using various communication devices 640 such as a wireless antenna, an RFID tag and/or short-range or near-field communication transceiver, each of which may optionally communicatively connect with other components of the device via one or more communication system. The communication device 640 may be configured to be communicatively connected to a communications network, such as the Internet, a local area network or a cellular telephone data network.

The hardware may also include a user interface sensor 645 that allows for receipt of data from input devices 650 such as a keyboard, a mouse, a joystick, a touchscreen, a touch pad, a remote control, a pointing device and/or microphone. Input such as digital image frames also may be received from a camera 620 that can capture video and/or still images.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion below, a client device, server device, virtual machine or container may be referred to simply as a “device” for brevity. Additional elements that may be included in electronic devices were discussed above in the context of FIG. 11.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The features and functions described above, as well as alternatives, may be combined into many other different systems or applications. Various alternatives, modifications, variations or improvements may be made by those skilled in the art, each of which is also intended to be encompassed by the disclosed embodiments.

1. A system for displaying hierarchical data via a graphical user interface, the system comprising:
a non-transitory memory storing a data set comprising hierarchical data elements, wherein each of the data elements:
is associated with a parent category and/or one or more child categories, and
is associated with metadata stored in the data set;
a display device, a processor, and a non-transitory computer-readable medium containing programming instructions that are configured to generate and cause the display device to dynamically display a visual representation of the data set in a concentric ring structure by:
selecting a first data element from the data set, wherein the first data element is associated with a parent category,
displaying, on the display device, the first data element in a cell of a central ring of the concentric ring structure,
extracting, from the data set, each additional data element that is associated with a category that is a child category of the parent category of the first data element,
displaying, on the display device, the extracted additional data elements in cells of a first outer ring that is outside of and adjacent to the central ring in the concentric ring structure,
identifying a filter to be applied to the visual representation, wherein the filter includes one or more parameters that, if satisfied by metadata of a data element displayed in any cell of the ring structure, will cause that cell to exhibit an altered appearance rather than a default appearance,
analyzing the first data element and a plurality of the additional data elements to identify each data element having associated metadata that satisfies the one or more parameters, and
causing the display device to present the concentric ring structure populated with the first data element and each additional data element in a visual representation in which:
each cell that displays a data element having associated metadata that satisfies the one or more parameters is displayed with an altered appearance; and
each cell that displays a data element having associated metadata that does not satisfy the one or more parameters is displayed with the default appearance.

2. The system of claim 1, in which the altered appearance comprises:
a background color that differs from a background color of the default appearance;
a font color that differs from a font color of the default appearance; or
a font appearance that differs from a font appearance of the default appearance.

3. The system of claim 1, wherein the programming instructions that are configured to generate and cause the display device to dynamically display the visual representation of the data set in the concentric ring structure further comprise additional programming instructions that are configured to:
for each additional data element contained in the first outer ring:
identify and extract, from the data set, any child data element that is associated with a child category of the category of the additional informational element,
cause the display device to display each child data element in a cell of a second outer ring of the concentric ring structure, wherein each cell that displays a child data element is adjacent to and outside of the cell that displays the additional data element from which it is a child,
analyze each child data element to identify whether it has associated metadata that satisfies the one or more parameters of the filter, and
cause the display device to present the second outer ring in a visual format in which:
each cell that displays a child data element having associated metadata that satisfies the one or more parameters is displayed with an altered appearance; and
each cell that displays a child data element having associated metadata that does not satisfy the one or more parameters is displayed with the default appearance.

4. The system of claim 1, wherein the programming instructions that are configured to generate and cause the display device to dynamically display the visual representation of the data set in the concentric ring structure further comprise additional programming instructions that are configured to:
receive a user input that comprises a selection of a new filter, and
cause the display device to present each cell in a visual format in which:
each cell that displays a data element having associated metadata that satisfies the new filter exhibits a newly altered appearance; and
each cell that displays a data element having associated metadata that does not satisfy the new filter exhibits an unchanged appearance.

5. The system of claim 1, wherein the programming instructions that are configured to generate and cause the display device to dynamically display the visual representation of the data set in the concentric ring structure further comprise additional programming instructions that are configured to output a comparison view by:
identifying an additional data set; and
causing the display device to also display the additional data set in a second concentric ring structure.

6. The system of claim 1, wherein the programming instructions that are configured to generate and cause the display device to dynamically display the visual representation of the data set in the concentric ring structure further comprise additional programming instructions that are configured to output a progression view by:
identifying one or more additional data sets, each of which is an earlier or later version of the data set; and
causing the display device to also display each additional data set in a second concentric ring structure.

7. The system of claim 5, further comprising additional programming instructions that are configured to, upon detection of a user selection of one of the displayed data elements in either of the concentric ring structures:
cause the display device to move the displayed data element to the central ring of each of the concentric ring structures;
identify and extract, from the data set, any child data element that is a child of the selected informational element; and
cause the display device to display each child data element in a corresponding cell of the first outer ring of each concentric ring structure.

8. The system of claim 6, further comprising additional programming instructions that are configured to, upon detection of a user selection of one of the displayed data elements in either of the concentric ring structures:
cause the display device to move the displayed data element to the central ring of each of the concentric ring structures;
identify and extract, from the data set, any child data element that is a child of the selected informational element; and
cause the display device to display each child data element in a corresponding cell of the first outer ring of each concentric ring structure.

9. The system of claim 1, wherein the display device and processor are components of a multi-function printing device.

10. A system for displaying hierarchical data via a graphical user interface, the system comprising:
a multi-function print device that comprises:
a print engine,
a display device,
a processor; and
a non-transitory memory programming instructions that are configured to generate and cause the display device to dynamically display hierarchical data in a concentric ring structure by causing the processor to:
access a data set of hierarchical data elements,
select a first data element from the data set, wherein the first data element is associated with a parent category,
cause the display device to display the first data element in a cell of a central ring of the concentric ring structure,
extract, from the data set, each additional data element that is associated with a category that is a child category of the parent category of the first informational element,
cause the display device to display, the extracted additional data elements in cells of a first outer ring that is outside of and adjacent to the central ring in the concentric ring structure,
identify a filter to be applied to the visual representation, wherein the filter includes one or more parameters that, if satisfied by a metadata associated with a data element displayed in any cell of the ring structure, will cause that cell to exhibit an altered appearance rather than a default appearance,
analyze the first data element and a plurality of the additional data elements to identify each data element having associated metadata that satisfies the one or more parameters, and
cause the display device to present the concentric ring structure populated with the first data element and each additional data element in a visual representation in which:
each cell that displays a data element having associated metadata that satisfies the one or more parameters is displayed with an altered appearance; and
each cell that displays a data element having associated metadata that does not satisfy the one or more parameters is displayed with the default appearance.

11. The system of claim 10, wherein the programming instructions that are configured to generate and cause the display device to dynamically display the hierarchical data in the concentric ring structure further comprise additional programming instructions that are configured to:
for each additional data element contained in the first outer ring:
identify and extract, from the data set, any child data element that is associated with a child category of the category of the additional informational element,
cause the display device to display each child data element in a cell of a second outer ring of the concentric ring structure, wherein each cell that displays a child data element is adjacent to and outside of the cell that displays the additional data element from which it is a child,
analyze each child data element to identify whether it has associated metadata that satisfies the one or more parameters of the filter, and
cause the display device to present the second outer ring in a visual format in which:
each cell that displays a child data element having associated metadata that satisfies the one or more parameters is displayed with an altered appearance; and
each cell that displays a child data element having associated metadata that does not satisfy the one or more parameters is displayed with the default appearance.

12. The system of claim 10, wherein the programming instructions that are configured to generate and cause the display device to dynamically display the hierarchical data in the concentric ring structure further comprise additional programming instructions that are configured to:
select a new filter; and
cause the display device to present each cell in a visual format in which:
each cell that displays a data element having associated metadata that satisfies the new filter exhibits a newly altered appearance, and
each cell that displays a data element having associated metadata that does not satisfy the new filter exhibits an unchanged appearance.

13. The system of claim 10, further comprising additional the programming instructions that are configured to cause the processor to cause the display device output a comparison view or progression view by:
identifying an additional data set; and
causing the display device to also display the additional data set in a second concentric ring structure.

14. The system of claim 13, wherein the programming instructions that are configured to cause the processor to cause the display device output a comparison view or progression view comprise instructions to select an earlier or later version of the data set when identifying the one or more additional data sets.

15. The system of claim 13, further comprising additional programming instructions that are configured to, upon detection of a user selection of one of the displayed data elements in either of the concentric ring structures:
cause the display device to move the displayed data element to the central ring of each of the concentric ring structures;
identify and extract, from the data set, any child data element that is a child of the selected informational element; and
cause the display device to display each child data element in a corresponding cell of the first outer ring of each concentric ring structure.

16. The system of claim 15, further comprising additional programming instructions that are configured to cause the processor to, upon detecting a user selection of a selected cell:
retrieve content that is associated with the data element of the selected cell by:
extracting, from the data set, content that is associated with the data element of the selected cell, or
identifying a content source from metadata of the data element of the selected cell, and accessing the content source to retrieve the content from the content source; and
cause the display device to display the retrieved content in a content field.

17. A method of displaying hierarchical data, the method comprising:
by a processing device, executing programming instructions that cause a display device to dynamically display hierarchical data in a concentric ring structure by:
accessing a data set of hierarchical data elements,
selecting a first data element from the data set, wherein the first data element is associated with a parent category,
causing the display device to display the first data element in a cell of a central ring of the concentric ring structure,
extracting, from the data set, each additional data element that is associated with a category that is a child category of the parent category of the first informational element,
causing the display device to display, the extracted additional data elements in cells of a first outer ring that is outside of and adjacent to the central ring in the concentric ring structure,
identifying a filter to be applied to the visual representation, wherein the filter includes one or more parameters that, if satisfied by metadata of information displayed in any cell of the ring structure, will cause that cell to exhibit an altered appearance rather than a default appearance,
analyzing the first data element and a plurality of the additional data elements to identify each data element having associated metadata that satisfies the one or more parameters, and
causing the display device to present the concentric ring structure populated with the first data element and each additional data element in a visual representation in which:
each cell that displays a data element having associated metadata that satisfies the one or more parameters is displayed with an altered appearance; and
each cell that displays a data element having associated metadata that does not satisfy the one or more parameters is displayed with the default appearance.

18. The method of claim 17, wherein causing the display device to dynamically display the hierarchical data in the concentric ring structure further comprises:
for each additional data element contained in the first outer ring:
identifying and extracting, from the data set, any child data element that is associated with a child category of the category of the additional informational element,
causing the display device to display each child data element in a cell of a second outer ring of the concentric ring structure, wherein each cell that displays a child data element is adjacent to and outside of the cell that displays the additional data element from which it is a child,
analyzing each child data element to identify whether it has associated metadata that satisfies the one or more parameters of the filter, and
causing the display device to present the second outer ring in a visual format in which:
each cell that displays a child data element having associated metadata that satisfies the one or more parameters is displayed with an altered appearance; and
each cell that displays a child data element having associated metadata that does not satisfy the one or more parameters is displayed with the default appearance.

19. The method of claim 17, wherein causing the display device to dynamically display the hierarchical data in the concentric ring structure further comprises:
selecting a new filter; and
causing the display device to present each cell in a visual format in which:
each cell that displays a data element having associated metadata that satisfies the new filter exhibits a newly altered appearance, and
each cell that displays a data element having associated metadata that does not satisfy the new filter exhibits an unchanged appearance.

20. The method of claim 18, further comprising causing the display device to output a comparison view or progression view by:
identifying an additional data set; and
causing the display device to also display the additional data set in a second concentric ring structure.

21. The method of claim 18, further comprising causing the display device to output a progression view by:
identifying an additional data set that is an earlier version or a later version of the data set; and
causing the display device to also display the additional data set in a second concentric ring structure.

22. The method of claim 20 further comprising, upon detection of a user selection of one of the displayed data elements in either of the concentric ring structures:
causing the display device to move the displayed data element to the central ring of each of the concentric ring structures;
identifying and extracting, from the data set, any child data element that is a child of the selected informational element; and
causing the display device to display each child data element in a corresponding cell of the first outer ring of each concentric ring structure.

23. The method of claim 17 further comprising, upon detection of a user selection of one of the displayed data elements in either of the concentric ring structures:
retrieving content that is associated with the data element of the selected cell by:
extracting, from the data set, content that is associated with the data element of the selected cell, or
identifying a content source from metadata of the data element of the selected cell, and accessing the content source to retrieve the content from the content source; and
causing the display device to display the retrieved content in a content field.
